(19) United States
(12) Patent Application Publication
(10) Pub. No.: US 2011/0025587 A1
(43) Pub. Date: Feb. 3, 2011

(54) Calibration Method for Improving Uniformity of Luminosity of Display Device and Related Device

(76) Inventor: Hsing-Chuan Chen, Taichung City (TW)

Correspondence Address: NORTH AMERICA INTELLECTUAL PROPERTY CORPORATION, P.O. BOX 506, MERRIFIELD, VA, 22116, US

(21) Appl. No.: 12/608,001

(22) Filed: Oct. 29, 2009

(30) Foreign Application Priority Data
Jul. 29, 2009 (TW) 098125483

(51) Int. Cl. G09G 3/36

(52) U.S. Cl. 345/87

(57) ABSTRACT

A calibration method utilized for improving the uniformity of luminosity of a display device includes controlling the display device to display a plurality of image data corresponding to a plurality of gray levels, detecting luminosity of each of the image data corresponding to each of the sampling points, to obtain a plurality of first luminosity signals corresponding to each of the sampling points, transforming the plurality of first luminosity signals into a plurality of second luminosity signals according to a transfer function, determining a linear calibration function corresponding to each of the sampling points according to the plurality of second luminosity signals and the plurality of gray levels corresponding to each of the sampling point, and calibrating the output luminosity of each of the sampling points, according to the linear calibration functions.

### BACKGROUND OF THE INVENTION

1. Field of the Invention

The present invention is related to a calibration method for a display device and related device, and more particularly, to a calibration method which can improve the uniformity of luminosity of a display device and the related device.

2. Description of the Prior Art

Till now, a video display technology has never stopped its pace to advance to a higher level of development and popularity. For example, in the recent years, liquid crystal display (LCD) devices or plasma display devices are getting more popular and are of better quality and higher resolution. About the image quality of the display device, not only the quality of the displayed color (or chrominance) should be good, but also the luminosity of the displayed image must be uniform among all the display elements (or pixels) while displaying the same image data. By taking the LCD device as an example, if a user observes an image displayed by the LCD device without any proper luminosity calibration, then he/she is likely to find the luminosity of different display areas are sometimes very different for the same gray level of image data. Furthermore, if some luminosity meters are applied to measure the displayed image, then it can be found that different pixels can have different observed luminosity value while displaying same gray level. Usually, by comparing the luminosity values in the central area and the boundary area of the display screen, a relatively large difference in luminosity can be observed. Under this condition, to make the luminosity uniform, a proprietary circuit must be designed and built in the product for luminosity calibration, and a strict luminosity calibration procedure must be applied in the production process of the display device.

In general, while in the prior art, the luminosity calibration method of a display device is focused on doing luminosity measurement and calibration according to a single gray level. For example, the calibration method of the prior art can perform luminosity calibration and compensation among pixels of a display device which can display up to 256 gray levels, and take a reference gray level (for example, 128) to do the luminosity measurement and calibration over all pixels. Therefore, this calibration method can assure the uniformity of luminosity only for a single gray level, and the experimental result shows that the luminosity error can still be over 20% for the rest of gray levels. Therefore, for making a quality display device of better luminosity uniformity (with luminosity error <10%), a more precise and trustable luminosity calibration method and procedure becomes very essential.

Taking an LCD device as an example, there could be many factors (e.g. the non-uniformity of light intensity from the backlight, the difference in pixel's optical characteristics, and the difference in pixel's driving voltage . . . ) may affect the luminous uniformity of the display device, and some method must be applied to compensate those factors to make the luminosity (of the display device) with better uniformity. Please refer to FIG. 1, which illustrates a schematic diagram of a luminosity calibrating device 10 of the prior art. The luminosity calibrating device 10 is utilized to execute a luminosity calibration process to a display device MONITOR1. Meanwhile, the luminosity calibrating device 10 is composed of an image control unit 100, a luminosity measuring unit 102 and a luminosity calibrating unit 104. The image control unit 100 is utilized to control the display device MONITOR1 to display an image corresponding to a specific gray level, the luminosity measuring unit 102 is utilized to measure the luminosity of a specific sampling point or area, and the luminosity calibrating unit 104 is utilized to calibrate the output luminosity of a specific sampling point.

Please refer to FIG. 2, which illustrates a schematic diagram of the luminosity of a display screen of a display device MONITOR1 of FIG. 1 to display an image signal of the same gray level. When the image control unit 100 controls the display screen to display a same gray level (e.g. 128), the pixel PIXEL_A in the center part of the screen is measured by the luminosity measuring unit 102, the detected luminosity can be set as a reference, and is given a luminosity value of 128. On the other hand, the observed luminosity values of the pixels PIXEL_B and PIXEL_C, which are close to the boundaries of the screen, are measured as 90 and 100, respectively. Therefore, if the luminosity calibrating unit 104 is to execute the luminosity calibration process specifically for the gray level of 128, then it can take pixel PIXEL_A as the reference pixel, and to increase the gray levels of pixels PIXEL_B and PIXEL_C by δE1 and δE2, respectively. In other words, 128+δE1 and 128+δE2 are the new gray levels which can make the luminosity of the pixels PIXEL_B and PIXEL_C to be equal to the luminosity of the reference pixel PIXEL_A. By repeating this calibration process, luminosity of all the pixels can be calibrated, and the calibrating values (e.g. δE1 and δE2) corresponding to each of the pixels are stored in a memory device in the display device MONITOR1, and while operating in the normal mode, the display device MONITOR1 can first take the gray level of the input pixel data and add up with the corresponding calibrating value stored in the memory device, and display the sum. Therefore, for a single gray level, the display device MONITOR1 can display image of uniform luminosity, but for the rest of gray levels, the uniformity in luminosity can not be guaranteed.

Besides that, for calibrating all the gray levels for a pixel on the display device MONITOR1, the prior art can also utilize the calibrating value obtained from the single gray level calibration mentioned above, and utilize a curve function to emulate the corresponding relationship between the luminosity and the gray level of the pixel. While in the operating mode, the display device MONITOR1 can then apply the curve function which fits the calibrated gray level to calculate the calibrating value of other gray levels in each of the pixel. However, in this way, the curve function utilized to emulate the corresponding relationship between the luminosity and the gray levels is not based on the real measurement; instead, it is based on designer's experience or just conjecture, and the calibrating value calculated according to the curve function may still have relatively large errors.

Briefly speaking, the calibration method mentioned above performs measurement and calibration of a specific gray level for each of the pixels on the display device. According to the modern display technology, the number of pixels in a single display device can be over a million, and if this measurement and calibration process is repeated for each of the single pixel on the display device, the total amount of time for a display device to complete the measurement and calibration process would be extremely long, and it could spend tens of hours to have only one display device done with luminosity calibration, so the production efficiency could be very much reduced. Besides that, while in the operating mode, the display device needs a memory space which is large enough to store all the calibrating value of all the pixels, the total amount of the memory space will be enormously large, so the material cost for the display device is then higher.

### SUMMARY OF THE INVENTION

Therefore, the main objective of the present invention is to provide a calibration method for a display device and the related device.

The present invention discloses a calibration method utilized for improving uniformity of luminosity of a display device having a plurality of sampling points, the calibration method comprising controlling the display device to display a plurality of image data corresponding to a plurality of gray levels; detecting a luminosity of each of the image data corresponding to each of the sampling points, to obtain a plurality of first luminosity signals corresponding to each of the sampling points; transforming the plurality of first luminosity signals into a plurality of second luminosity signals according to a transfer function; determining linear calibration functions each corresponding to one of the sampling points according to the plurality of the second luminosity signals and the plurality of gray levels corresponding to each of the sampling points; and calibrating the output luminosity of each of the sampling points according to the linear calibration functions corresponding to each of the sampling points.

The present invention further discloses a calibration device utilized for improving uniformity of luminosity of a display device having a plurality of sampling points, the calibration device comprising an image control unit, for controlling the display device to display a plurality of image data corresponding to a plurality of gray levels; a luminosity measurement unit, for detecting a luminosity of each of the image data corresponding to each of the sampling points, to obtain a plurality of first luminosity signals corresponding to each of the sampling points; a signal conversion unit, for transforming the plurality of first luminosity signals into a plurality of second luminosity signals, according to a transfer function; a function determination unit, for determining linear calibration functions each corresponding to one of the sampling points according to the plurality of the second luminosity signals and the plurality of gray levels corresponding to each of the sampling points; and a luminosity calibration unit, for calibrating the output luminosity of each of the sampling points according to the linear calibration functions corresponding to each of the sampling points.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a luminosity calibrating device of the prior art.

FIG. 2 illustrates a schematic diagram of the luminosity of a display screen of a display device of FIG. 1 to display an image signal of the same gray level.

FIG. 3 illustrates a schematic diagram of a calibration device according to an embodiment of the present invention.

FIG. 4A to FIG. 4C are schematic diagrams of linear calibration functions corresponding to two distinct sampling points.

FIG. 5A and FIG. 5B illustrate two distribution diagrams of sampling points according to an embodiment of the present invention.

FIG. 6 illustrates a schematic diagram of a calibration process according to an embodiment of the present invention.

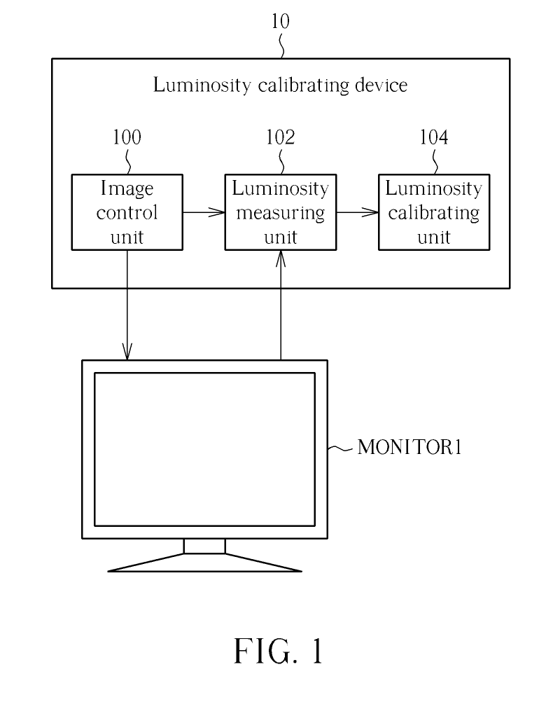

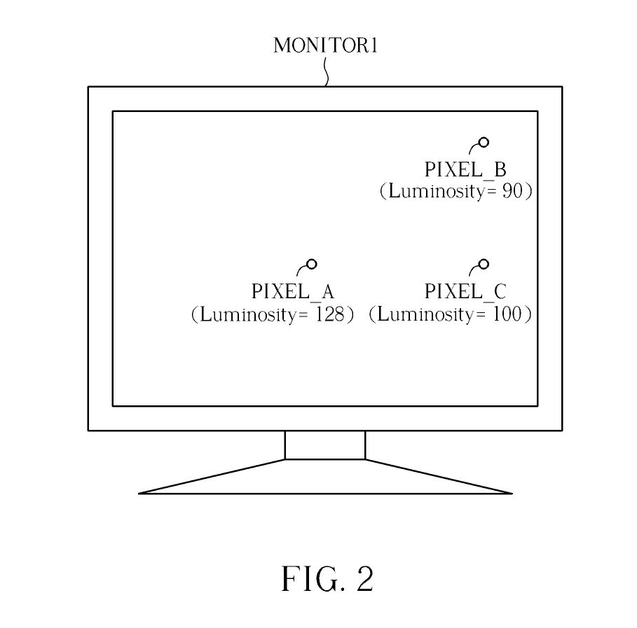

### DETAILED DESCRIPTION

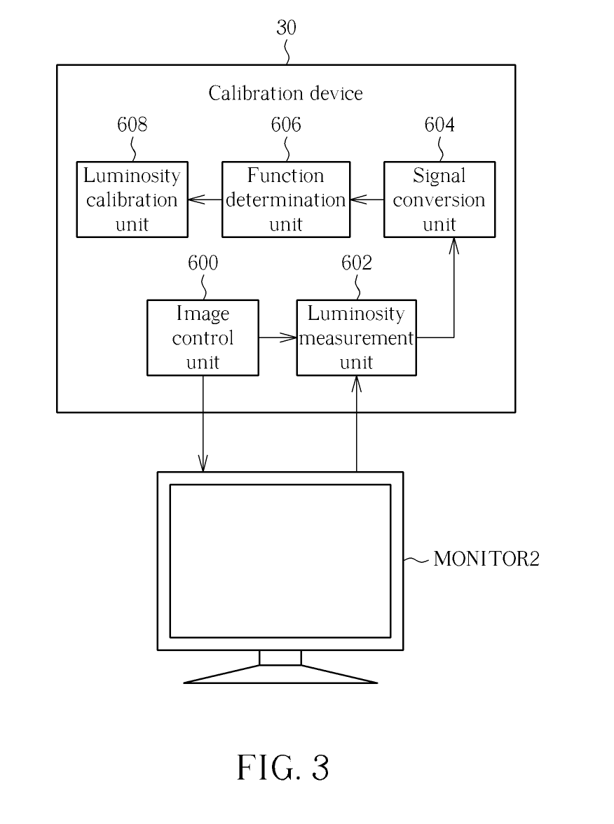

Please refer to FIG. 3, which illustrates a schematic diagram of a calibration device 30 according to an embodiment of the present invention. The calibration device 30 is utilized to carry out a luminosity calibration to a display device MONITOR2 in order to enhance the uniformity of luminosity. The display device MONITOR2 comprises M sampling points SP_{—}1˜SP_M, which are evenly distributed on the screen of the display device MONITOR2. The calibration device 30 comprises an image control unit 600, a luminosity measurement unit 602, a signal conversion unit 604, a function determination unit 606 and a luminosity calibration unit 608. The image control unit 600 is utilized to control the display device MONITOR2 to display image data PIC_{—}1˜PIC_N, and the image data PIC_{—}1˜PIC_N are corresponding to K different gray levels GL_{—}1˜GL_K. The luminosity measurement unit 602 is utilized to detect the luminosity of the sampling points SP_{—}1˜SP_M by displaying the image data PIC_{—}1˜PIC_N, and to obtain the luminosity signals LO_{—}1˜LO_M corresponding to each of the sampling points SP_{—}1˜SP_M. The signal conversion unit 604 transforms the luminosity signals LO_{—}1˜LO_M, corresponding to the sampling points SP_{—}1˜SP_M, into another luminosity signals NL_{—}1˜NL_M, according to a transfer function LOG. The function determination unit 606 is utilized to determine linear calibration functions GC_{—}1˜GC_M corresponding to each of the sampling points SP_{—}1˜SP_M, according to the luminosity signals NL_{—}1˜NL_M and gray levels GL_{—}1˜GL_K. The luminosity calibration unit 608 is utilized to calibrate the output luminosity of the sampling points SP_{—}1˜SP_M, according to the linear calibration functions GC_{—}1˜GC_M corresponding to the sampling points SP_{—}1˜SP_M.

Briefly speaking, when the luminosity measuring unit 602 obtains the luminosity signals LO_{—}1LO_M corresponding to the sampling points SP_{—}1˜SP_M, the signal conversion unit 604 converts the luminosity signals LO_{—}1˜LO_M corresponding to the sampling points SP_{—}1˜SP_M into the luminosity signals NL_{—}1˜NL_M through the transfer function LOG, and together with the gray levels GL_{—}1˜GL_K of the original image data, the function determination unit 606 decides the linear calibration functions GC_{—}1˜GC_M corresponding to the sampling points SP_{—}1˜SP_M. In this way, the luminosity determination unit 608 calibrates the output luminosity of the sampling points SP _{—}1˜SP_M according to the linear calibration functions GC_{—}1˜GC_M. Preferably, the transfer function LOG is a logarithmic function, and when the gray level and the luminosity undergo conversion according to function LOG, the mathematical relationship between the two can be converted into a linear relationship. In this way, the relationship between the gray level and the luminosity after the conversion will become greatly simplified. For example, the function decision unit 606 can utilize the best fit method to determine the parameter values included in a linear calibration function for each of the sampling points, or using the linear interpolation approach to establish the gamma table for each of the gray levels of each of the sampling points SP_{—}1˜SP_M. Therefore, the present invention does not need to measure the luminosity for each of the gray levels, while a highly accurate calibration result can still be acquired.

To detail further, for the display device MONITOR2, the relationship between luminosity and gray level can be expressed by an exponential function. However, since the exponential function is a nonlinear function, it is unable to use linear interpolation to derive a luminosity look up table (Gamma Table) for every gray level. On the contrary, if the logarithmic function is to be applied to perform functional transformation to the luminosity and to the gray level, then the corresponding relationship between the two can be changed from the nonlinear exponential functional relationship to a linear one.

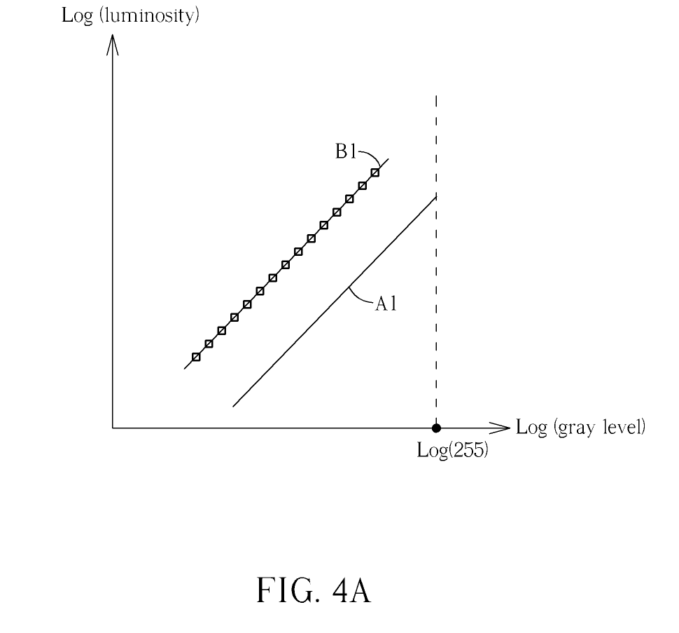

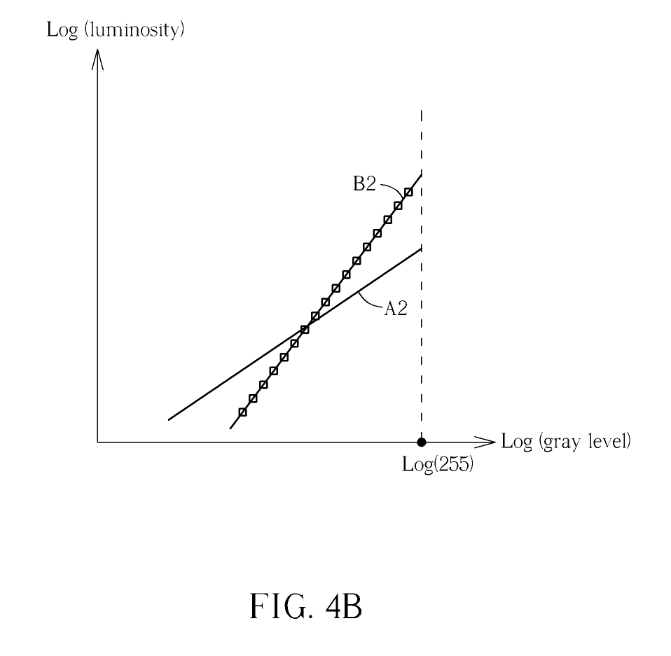

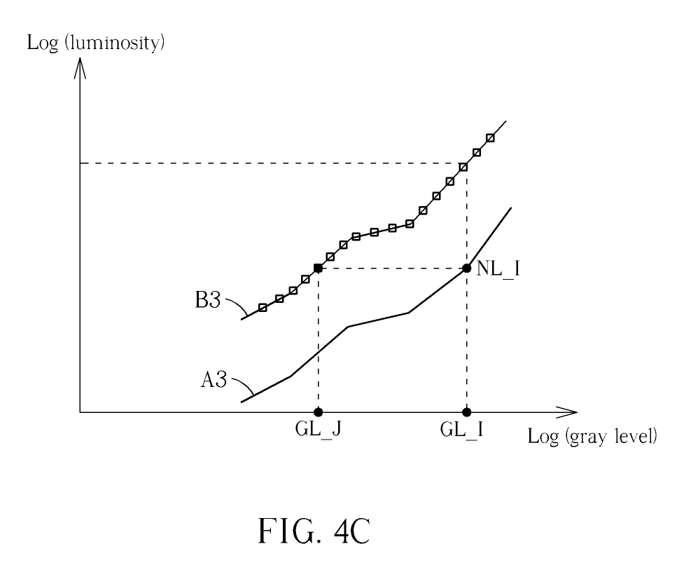

On the other hand, for performing the luminosity calibration more effectively, the operator of the calibration device 30 can select a sampling point as a reference pixel SSP, and the rest of sampling points can then take the linear calibration function of this reference point SSP as the reference (or the basis of comparison) to perform luminosity calibration. Also, the method of deriving the look up table will heavily rely on the relative position (in the converted coordinate) of the linear calibration functions of the reference pixel and the rest of the sampling points. About the relative positions of the reference pixel and the rest of the sampling points, please refer to one of the three conditions depicted in FIG. 4A to FIG. 4C. FIG. 4A to FIG. 4C are schematic diagrams of linear calibration functions corresponding to two distinct sampling points.

Condition 1: As demonstrated in FIG. 4A, the linear calibration functions of the reference pixel and the other sampling points display a parallel relationship. Noticeably, the condition displayed in FIG. 4A is the mostly often seen condition. Under this condition, the linear calibration function of the reference pixel SSP (Curve A1) and the linear calibration function of the other pixel or sampling point (Curve B1) are of the same slope. To calibrate the luminosity is to move the Curve B1 to overlap with Curve A1, and this can be done by calculating the luminosity difference of the same gray level between Curves A1 and B1, and deriving the difference (δE) between the corresponding gray level and the new gray level after adjustment. By this way, the present invention can quickly derive the gamma table for every sampling pixel.

Condition 2: As demonstrated in FIG. 4B, the linear calibration functions of the reference pixel and the other sampling points display the two curves with different slope and gray-level intercept. Under this condition, the slope of the linear calibration function of the reference pixel SSP (Curve A2) and the slope of the linear calibration function of the other pixel or sampling point (Curve B2) are different. To derive the difference (δE) between the corresponding gray level and the new gray level after adjustment, to make Curve B2 overlap with the Curve A2, the maximum gray level (the maximum gray level equals 255 in this case) and its corresponding luminosity can be taken as the basis of comparison, and the gamma table for every sampling pixel can also be derived in a short time.

Condition 3: As demonstrated in FIG. 4C, the linear calibration functions of the reference pixel and the other sampling points are approximately parallel to each other but the slope is not a constant. Under this condition, a gray level GL_I is selected first. Next, find a luminosity NL_I corresponding to gray level GL_I on the linear calibration function (Curve A3) corresponding to the reference pixel. Then, find the gray level GL_J corresponding to luminosity NL_I on the linear calibration function of the other pixel (Curve B3). By following this step, the difference (δE) between the corresponding gray level and the new gray level after adjustment can be derived, and the gamma table for every sampling pixel can be derived accordingly.

Besides that, the luminosity calibration unit 608 can also apply a way of computing the weighted sum to calculate the luminosity calibrating value of the pixels other than the sampling pixel, according to the luminosity calibrating value of the neighboring sampling pixels, such that luminosity of every pixel on the screen can be calibrated. In other words, the present invention can calibrate the output luminosity of the other part (pixel) according to the linear calibrating functions of every sampling point. Furthermore, the weighted values utilized to calculate the weighted sum are corresponding to the distances between the said pixel and the neighboring sampling pixels, and as the distance increases, the weighted value will get less, and vice versa.

To make a summary according to the above, firstly, the present invention selects a sampling pixel as the reference pixel, such that the other pixel can take the reference pixel as a reference for calibration. After the sampling pixels (including reference pixel and the other sampling pixels) is measured by utilizing the luminosity measurement unit 602 to obtain 3˜16 different sets of measurements, each including the relationship between the luminosity and the gray level, the signal conversion unit 604 applies transfer function LOG to perform a coordinate transformation, to convert the original exponential relation between the pixel's luminosity and the gray level into a linear relation between the converted coordinate. Therefore, the function determination unit 606 can apply the linear interpolation method to establish the linear calibrating function proprietary to each of the sampling pixel and can be utilized to derive the other relationships between the luminosity and the gray level without really making the measurements. Next, the luminosity calibration unit 608 calculates and derives the Gamma Table utilized to adjust the input gray level value of the sampling pixel, according to the linear calibrating function of the sampling pixel by comparing with the linear calibrating function of the reference pixel, and the input gray level can be converted into a new gray level according to the derived Gamma Table, such that the newly converted gray level can have the same luminosity approximately equal to the reference pixel. To sum up, the major function of the calibration device 30 is to derive the relationships between every gray level and the corresponding new gray level of every pixel (δE).

On the other hand, it is noteworthy that the calibration device 30 can also be applied to the luminosity calibration of a single color; for example, the three primary colors (red, green and blue) of display devices can also apply the calibration device 30 to do individual single-color luminosity calibration.

Also, since the calibration method of the prior art does not include a coordinate transform, such that the functional relationships between the luminosity and the gray level display a nonlinear relationship, and is not suitable for utilizing the linear interpolation to derive the Gamma Table. Therefore, for achieving better precision, the prior art can only use many more measurements to establish a Gamma Table, and this will make the measurement time too long and the cost too high. Next, the prior art also shows using single or a few of the actual measured values, coupled with curves based upon experience or conjecture, to barely fit into the measurement results, so often it is unable to get a more accurate Gamma Table. In contrast, the present invention discloses the calibration device 30 can either make a substantial reduction in the measurement time and can save most of the memory space used by the Gamma Table, and gets more accurate results in the luminosity calibration.

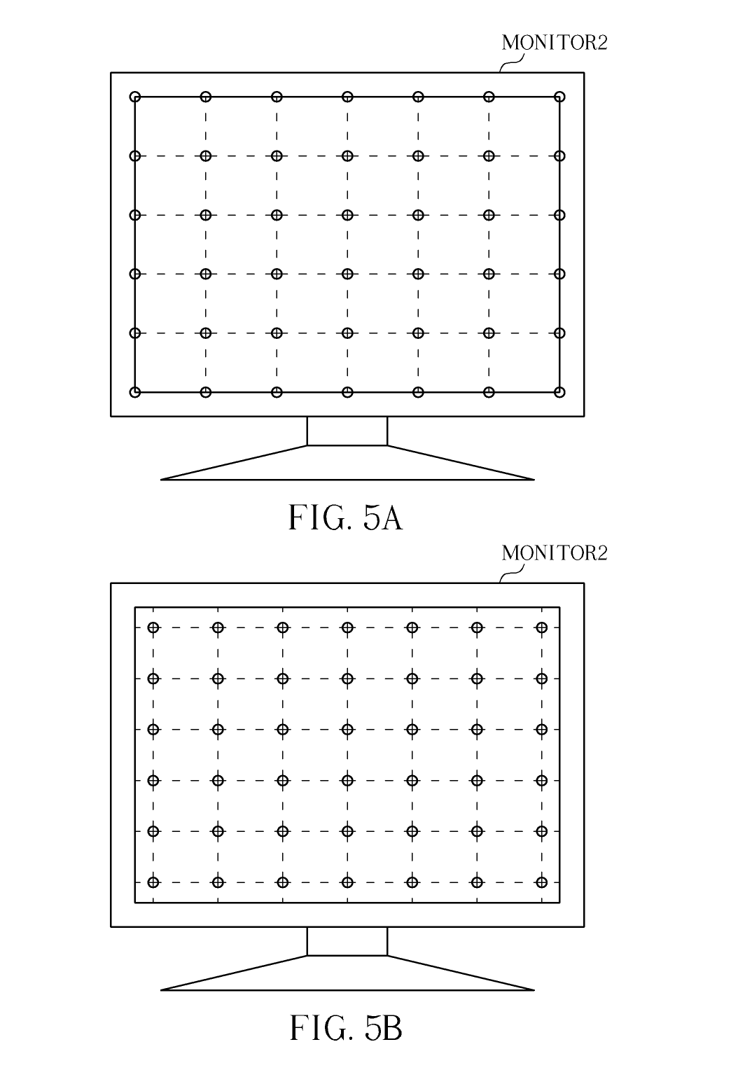

Besides that, for improving the efficiency of luminosity calibration, the present invention follows certain rules in choosing the sampling points. Please refer to FIG. 5A and FIG. 5B, which illustrate two distribution diagrams of the sampling points. Noteworthily, in FIG. 5B, there is a certain distance between the sampling points close to the screen boundary and the screen boundary, and it can help to decrease the errors of measurement to a minimal.

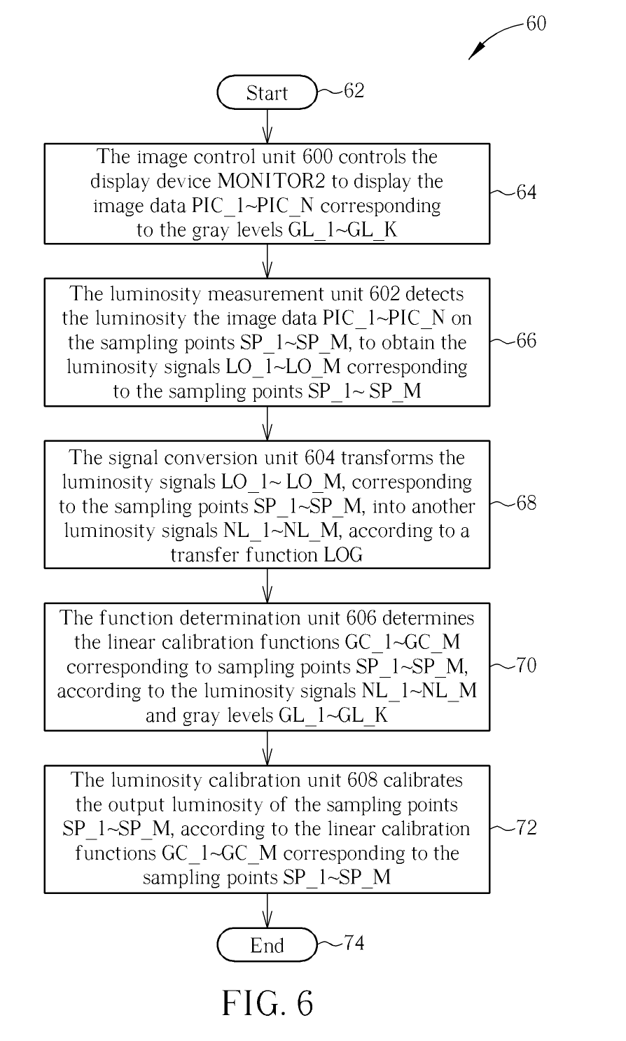

The operations of the calibration device 30 can then be organized to establish a calibration process 60 as depicted in FIG. 6. The calibration process 60 comprises the following steps:

STEP 62: Start.

STEP 64: The image control unit 600 controls the display device MONITOR2 to display the image data PIC_{—}1˜PIC_N corresponding to the gray levels GL_1˜GL_K.

STEP 66: The luminosity measurement unit 602 detects the luminosity the image data PIC_{—}1˜PIC_N on the sampling points SP_{—}1˜SP_M, to obtain the luminosity signals LO_{—}1˜LO_M corresponding to the sampling points SP_{—}1˜SP_M.

STEP 68: The signal conversion unit 604 transforms the luminosity signals LO_{—}1˜LO_M, corresponding to the sampling points SP_{—}1˜SP_M, into another luminosity signals NL_{—}1˜NL_M, according to a transfer function LOG.

STEP 70: The function determination unit 606 determines the linear calibration functions GC_{—}1˜GC_M corresponding to sampling points SP_{—}1˜SP_M, according to the luminosity signals NL_{—}1˜NL_M and gray levels GL_{—}1˜GL_K.

STEP 72: The luminosity calibration unit 608 calibrates the output luminosity of the sampling points SP_{—}1˜SP_M, according to the linear calibration functions GC_{—}1˜GC_M corresponding to the sampling points SP_{—}1˜SP_M.

STEP 74: End.

To sum up, the present invention discloses a luminosity calibrating method and device. By applying the present invention, a mathematical transfer function is utilized to transform a certain amount (about 3˜16) of luminosity and their corresponding gray levels to perform a coordinate transform. The original unpleasant form of the exponential relation between the luminosity vs. the gray level is then transformed into a much simpler form of linear relation. Then, a linear interpolation method is applied to generate luminosity look up table for each of the sampling pixels or area. Furthermore, the present invention calculates the weighted sum to obtain the luminosity calibrating value of the pixels which are not the sampling pixel, according to the luminosity look up tables of the neighboring sampling pixels. Finally, the luminosity of every pixel of the image can be calibrated with high efficiency.

According to the experimental result, by using the look up table of the present invention to perform the luminosity calibration, the luminosity error can be reduced to within 10%. The time used for completing the luminosity calibration of a display device can be shortened from tens of hours to a few minutes, the benefits is very obvious.

Those skilled in the art will readily observe that numerous modifications and alterations of the device and method may be made while retaining the teachings of the invention.

What is claimed is:

1. A calibration method utilized for improving uniformity of luminosity of a display device having a plurality of sampling points, the calibration method comprising:
controlling the display device to display a plurality of image data corresponding to a plurality of gray levels;
detecting a luminosity of each of the image data corresponding to each of the sampling points, to obtain a plurality of first luminosity signals corresponding to each of the sampling points;
transforming the plurality of first luminosity signals into a plurality of second luminosity signals according to a transfer function;
determining linear calibration functions each corresponding to one of the sampling points according to the plurality of the second luminosity signals and the plurality of gray levels corresponding to each of the sampling points; and
calibrating the output luminosity of each of the sampling points according to the linear calibration functions corresponding to each of the sampling points.

2. The calibration method of claim 1, wherein the transfer function is a logarithmic function.

3. The calibration method of claim 1, wherein the step of determining the linear calibration functions corresponding to each of the sampling points, according to the plurality of the second luminosity signals is utilizing a best fit method to determine parameters comprised in the linear calibration functions corresponding to each of the sampling points according to the plurality of second luminosity signals corresponding to each of the sampling points.

4. The calibration method of claim 1, wherein the plurality of sampling points are corresponding to a part of a display area of the display device.

5. The calibration method of claim 4 further comprising calibrating the output luminosity of the rest part of the display area according to the linear calibration function corresponding to each of the sampling points.

6. The calibration method of claim 1, wherein the plurality of the sampling points are corresponding to a part of a plurality of pixels of the display device.

7. The calibration method of claim 6 further comprising calibrating the output luminosity of the rest part of the plurality of pixels according to the linear calibration function corresponding to each of the sampling points.

8. A calibration device utilized for improving uniformity of luminosity of a display device having a plurality of sampling points, the calibration device comprising:
an image control unit, for controlling the display device to display a plurality of image data corresponding to a plurality of gray levels;
a luminosity measurement unit, for detecting a luminosity of each of the image data corresponding to each of the sampling points, to obtain a plurality of first luminosity signals corresponding to each of the sampling points;
a signal conversion unit, for transforming the plurality of first luminosity signals into a plurality of second luminosity signals, according to a transfer function;
a function determination unit, for determining linear calibration functions each corresponding to one of the sampling points according to the plurality of the second luminosity signals and the plurality of gray levels corresponding to each of the sampling points; and
a luminosity calibration unit, for calibrating the output luminosity of each of the sampling points according to the linear calibration functions corresponding to each of the sampling points.

9. The calibration device of claim 8, wherein the transfer function is a logarithmic function.

10. The calibration device of claim 8, wherein the function determination unit utilizes a best fit method to determine parameters comprised in the linear calibration functions corresponding to each of the sampling points according to the plurality of second luminosity signals corresponding to each of the sampling points.

11. The calibration device of claim 8, wherein the plurality of sampling points are corresponding to a part of a display area of the display device.

12. The calibration device of claim 11, wherein the luminosity calibration unit is utilized for calibrating the output luminosity of the rest part of the display area according to the linear calibration function corresponding to each of the sampling points.

13. The calibration device of claim 8, wherein the plurality of the sampling points are corresponding to a part of a plurality of pixels of the display device.

14. The calibration device of claim 13, wherein the luminosity calibration unit is utilized for calibrating the output luminosity of the rest part of the plurality of pixels according to the linear calibration function corresponding to each of the sampling points.
